(19) United States
(12) Patent Application Publication
(10) Pub. No.: US 2016/0029334 A1
(43) Pub. Date: Jan. 28, 2016

(54) METHOD AND APPARATUS FOR SYNCHRONIZING NETWORKS AMONG HETEROGENEOUS WIRELESS OPERATORS

(71) Applicant: Electronics and Telecommunications Research Institute, Daejeon (KR)

(72) Inventors: Kapseok CHANG, Daejeon (KR); Byung-Jae KWAK, Daejeon (KR)

(21) Appl. No.: 14/808,954

(22) Filed: Jul. 24, 2015

(30) Foreign Application Priority Data
Jul. 25, 2014 (KR) 10-2014-0094861
Jul. 23, 2015 (KR) 10-2015-0104455

(51) Int. Cl. H04W 56/00; H04W 16/16; H04B 15/00; H04W 24/08

(52) U.S. Cl. CPC H04W 56/0015; H04W 24/08; H04W 16/16; H04B 15/00; H04W 84/045

(57) ABSTRACT

Disclosed are a method and an apparatus for synchronizing networks among heterogeneous wireless business operators. A terminal belonging to a first network monitors whether there is a different network in a monitoring period of a frame. The terminal synchronize a frame start synchronization point of the first network with a frame start synchronization point of a second network that corresponds to a discovered synchronization point when the synchronization point having a time offset of as much as a predetermined number of periods is discovered.

### CROSS-REFERENCE TO RELATED APPLICATION

This application claims priority to and the benefit of Korean Patent Application No. 10-2014-0094861 and No. 10-2015-0104455 filed in the Korean Intellectual Property Office on Jul. 25, 2014 and Jul. 23, 2015, the entire contents of which are incorporated herein by reference.

### BACKGROUND OF THE INVENTION

(a) Field of the Invention

The present invention relates to a method and apparatus for synchronizing networks among heterogeneous wireless business operators.

(b) Description of the Related Art

When terminals are synchronized with each other in a wireless communication system, advantages are provided, and a synchronization scheme is used in mobile communication systems such as a Long-Term Evolution (LTE) system. The synchronization scheme represent a case in which terminals share start points of periodically repeated frames and each frame is divided into periods. The synchronization scheme has a merit of saving power of a terminal in a sleep mode. Generally, a terminal in a sleep mode has to monitor information to be needed rather than unconditionally turning off power. A specific period of a frame can be allowed to transmit information in the synchronization scheme. Accordingly, the terminal in a sleep mode operates a reception mode or a transmission mode in the specific period and turns off power in the periods except for the specific period to save a battery.

The LTE system using the synchronization scheme uses licensed bands and provides voice/image/data/Internet services of high quality with high frequency efficiency to terminals. However, frequency efficiency needs to be increased by 1000 times compared to the existing efficiency in a mobile communication system because of a rapid increase of data traffic. The demand for traffic capacity has been increasing exponentially, and thereby it reaches the limit to meet the demand with resources of unlicensed bands. Accordingly, the range of services is becoming more and more expanded to unlicensed bands. With unlicensed bands, a Device-to-Device (D2D) based In-band Half Duplex (IHD)/Out-band Full Duplex (OFD) between terminals which belong to a base station of an LTE system, and one step further for increasing traffic capacity, a D2D based In-band Full Duplex (IFD), are expected to be realized. Here, the IHD represents that transmitting/receiving is performed by dividing time resources at the same frequency bandwidth, the OFD represents that transmitting/receiving is performed by simultaneously using time resources at the different frequency bandwidths, and the IFD represents that transmitting/receiving is performed using simultaneously time resources at the same frequency bandwidth. If the IFD is realized, frequency resources and time resources can be optimally used, and thereby traffic capacity increases.

When some of terminals which belong to a base station perform a D2D communication by moving an unlicensed band or by simultaneously using a licensed band and an unlicensed band, it is possible to maintain synchronization between the terminals using the unlicensed band because the base station can provide various information on synchronization and other information to terminals through a control channel in a licensed band.

In an environment in which base stations of other specific wireless operators coexist in a region that a base station of a specific wireless operator controls or in its neighboring region, it causes interference with each other by synchronization mismatch between networks (herein, it represents that some of terminals using unlicensed bands among terminals belonging to a specific base station are constructed). As a result, the problem causing the overall local system capacity reduction occurs.

Specifically, it is assumed that start points of frames are synchronized between terminals in a network belonging to a wireless operator A, start points of frames are synchronized between terminals in a network belonging to a wireless operator B, and start points of frames are not synchronized between the network of wireless operator A and the network of the wireless operator B. In the case in which the networks are asynchronous, when a period of the network in the wireless operator A has a different function from that of a period of the network in the wireless operator B and they overlap, each network acts as interference to another network. As a result, the problem causing the resource use efficiency to be deteriorated occurs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for synchronizing at least two asynchronous networks when a wireless communication system uses an unlicensed band.

An exemplary embodiment of the present invention provides a method for synchronizing networks based on an unlicensed band. The method includes: monitoring, by a terminal belonging to a first network, whether there is a different network in a monitoring period of a frame; discovering a synchronization point having a time offset of as much as a predetermined number of periods; and synchronizing a frame start synchronization point of the first network with a frame start synchronization point of a second network that corresponds to the discovered synchronization point.

The synchronizing may include synchronizing a frame start synchronization point of the first network with a frame start synchronization point of a second network that corresponds to the discovered synchronization point when the synchronization point is discovered and then a predetermined time is passed.

The method may further include, between the discovering and the synchronizing, transmitting offset information after the synchronization point is discovered, wherein, the transmitting of offset information transmits the offset information in a start time portion of the frame of the first network or other periods of the frame.

The offset information may include one among first information indicating not moving to the second network corresponding to the discovered synchronization point, second information indicating moving to the second network corresponding to the discovered synchronization point, and third information indicating moving to the second network corresponding to the discovered synchronization point the time offset.

The method may further include, after the synchronizing, transmitting information indicating maintaining frame synchronization in a start time portion of a frame of the second network.

Alternatively, the method may further include, between the discovering and the synchronizing, confirming information transmitted in a predetermined period of a frame of the second network, wherein the confirming may confirm information transmitted in a start time portion of a frame of the second network or other periods of the frame.

The synchronizing may include synchronizing a frame start synchronization point of the first network with a frame start synchronization point of a second network that corresponds to the discovered synchronization point when the confirmed information indicates maintain frame synchronization.

Alternatively, the method may further include, between the discovering and the synchronizing, selecting one from among a plurality of synchronization points when the plurality of synchronization points are discovered, wherein the selecting may include selecting a synchronization point of which a time offset satisfies a predetermined condition from the discovered plurality of synchronization points, and the synchronizing may include synchronizing a frame start synchronization point of the first network with a frame start synchronization point of a second network that corresponds to the selected synchronization point.

Another exemplary embodiment of the present invention provides a method for synchronizing at least three networks based on an unlicensed band, wherein the at least three networks monitor in a monitoring period that arrives based on monitoring period arrival order. The method includes: monitoring, by a terminal belonging to a first network among the at least three networks, in a monitoring period of a frame, whether a synchronization point is discovered in different time points from a start point of the frame; operating in a re-synchronization mode when at least one synchronization point is discovered in the monitoring period and synchronizing a frame start synchronization point of the first network with a frame start synchronization point of a second network that corresponds to the discovered synchronization point; and operating in a maintaining synchronization mode when a synchronization point is discovered in the monitoring period.

The method may further include: monitoring, by a terminal belonging to a second network among networks except the first network, in a monitoring period of a frame, whether a synchronization point is discovered; operating, by the terminal belonging to the second network, in a maintaining synchronization mode when a synchronization point that is equal to its frame start point and has a different frame number from that of its frame is discovered; and synchronizing, by the terminal belonging to the second network, a frame start synchronization point of the second network with a frame start synchronization point of a network that corresponds to a discovered synchronization point when the synchronization point that is not equal to its frame start point and has a different frame number from that of its frame is discovered.

Alternatively, the method may further include: monitoring, by a terminal belonging to a second network that is synchronized with the first network among networks except the first network, in a monitoring period of a frame, whether a synchronization point is discovered; operating, by the terminal belonging to the second network, in a maintaining synchronization mode when a synchronization point that is equal to its frame start point and has a different frame number from that of its frame is discovered; synchronizing, by the terminal belonging to the second network, a frame start synchronization point of the second network with a frame start synchronization point of a network that corresponds to a discovered synchronization point when the synchronization point that is not equal to its frame start point and has a different frame number from that of its frame is discovered; monitoring, by a terminal belonging to a third network that is not synchronized with the first network among networks except the first network, in a monitoring period of a frame, whether a synchronization point is discovered; operating, by the terminal belonging to the third network, in a maintaining synchronization mode when a synchronization point that is equal to its frame start point and has a different frame number from that of its frame is discovered; and selecting, by the terminal belonging to the third network, one among discovered synchronization points based on a predetermined condition when the synchronization points that are not equal to its frame start point and have a different frame number from that of its frame are discovered, and synchronizing a frame start synchronization point of the third network with a frame start synchronization point of a network that corresponds to the selected synchronization point.

The method may further include operating, by the terminal belonging to the second network, in a maintaining synchronization mode when a synchronization point that is or is not equal to its frame start point and has a different frame number from that of its frame is not discovered.

The first network may be a network except networks that are synchronized with each other among at least three networks and the networks that are synchronized with each other have not performed monitoring, wherein the synchronizing of a frame start synchronization point may include synchronizing, by the terminal belonging to first second network, a frame start synchronization point of the first network with a frame start synchronization point of a network that corresponds to a discovered synchronization point when the synchronization point that is not equal to its frame start point and has a different frame number from that of its frame is discovered.

The operating in a maintaining synchronization mode may include: operating, by the terminal belonging to the first third network, in a maintaining synchronization mode when a synchronization point that is equal to its frame start point and has a different frame number from that of its frame is discovered; and operating, by the terminal belonging to the first network, in a maintaining synchronization mode when a synchronization point that is or not equal to its frame start point and has a different frame number from that of its frame is not discovered.

The terminal may receive control information on a length of a monitoring period or a cycle of a monitoring period through a control channel from a base station of a network to which the terminal belongs or through other terminals that belong to other networks.

Yet, another exemplary embodiment of the present invention provides an apparatus for synchronizing networks based on an unlicensed band. The apparatus includes: a wireless frequency converter configured to transmit/receive a signal through an antenna; and a processor connected to the wireless frequency converter and configured to control transmission of the signal, wherein the processor includes: a monitoring processor configured to monitor whether there is a different network in a monitoring period of a frame of a first network; and a synchronization processor configured to synchronize a frame start synchronization point of the first network with a frame start synchronization point of a second network that corresponds to the discovered synchronization point when the synchronization point having a time offset of as much as a predetermined number of periods is discovered.

The apparatus may further include an information transmission processor configured to transmit offset information in a start time portion of the frame of the first network or other periods of the frame.

The offset information may include one among first information indicating not moving to the second network corresponding to the discovered synchronization point, second information indicating moving to the second network corresponding to the discovered synchronization point, and third information indicating moving to the second network corresponding to the discovered synchronization point the time offset.

The information transmission processor may transmit information indicating maintaining frame synchronization in a start time portion of a frame of the second network after the synchronization is performed by the synchronization processor.

The apparatus may further include an information confirm processor configured to confirm information transmitted in a predetermined period of a frame of the second network, wherein the synchronization processor may synchronize a frame start synchronization point of the first network with a frame start synchronization point of a second network that corresponds to the discovered synchronization point when the confirmed information indicates maintain frame synchronization.

### BRIEF DESCRIPTION OF THE DRAWINGS

FIG. 1 shows a heterogeneous network environment according to an exemplary embodiment of the present invention.

FIG. 2 shows an example of a frame structure according to an exemplary embodiment of the present invention.

FIG. 3 shows a process for synchronizing networks according to an exemplary embodiment of the present invention.

FIG. 4 shows a flowchart of the first synchronization method according to the first exemplary embodiment of the present invention.

FIG. 5 shows a flowchart of the second synchronization method according to the first exemplary embodiment of the present invention.

FIG. 6 shows a flowchart of the third synchronization method according to the first exemplary embodiment of the present invention.

FIG. 7 shows a flowchart of a method for synchronizing according to the second exemplary embodiment of the present invention.

FIG. 8 shows a flowchart of a method for synchronizing according to the third exemplary embodiment of the present invention.

FIG. 9 shows a flowchart of a method for synchronizing according to the fourth exemplary embodiment of the present invention.

FIG. 10 shows a flowchart of a method for synchronizing according to the fifth exemplary embodiment of the present invention.

FIG. 11 shows the state transition of modes according to an exemplary embodiment of the present invention.

FIG. 12 shows a block diagram illustrating a configuration of an apparatus for synchronizing networks according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification, unless explicitly described to the contrary, the word “comprise” and variations such as “comprises” or “comprising” will be understood to imply the inclusion of stated elements but not the exclusion of any other elements.

In this specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the MT, the MS, the AMS, the HR-MS, the SS, the PSS, the AT, the UE, etc.

A base station (BS) may designate an advanced base station (ABS), a high reliability base station (HR-BS), a node B (nodeB), an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (HR-RS) serving as a base station, a high reliability relay station (HR-RS) serving as a base station, a small base station (a femto BS, a home node B (HNB), a home eNodeB (HeNB), a pico BS, a metro BS, a micro BS, etc.), etc., and may include all or some functions of the ABS, the nodeB, the eNodeB, the AP, the RAS, the BTS, the MMR-BS, the RS, the RN, the ARS, the HR-RS, the small base station, etc.

Hereinafter, a method and apparatus for synchronizing networks according to an exemplary embodiment of the present invention will be described.

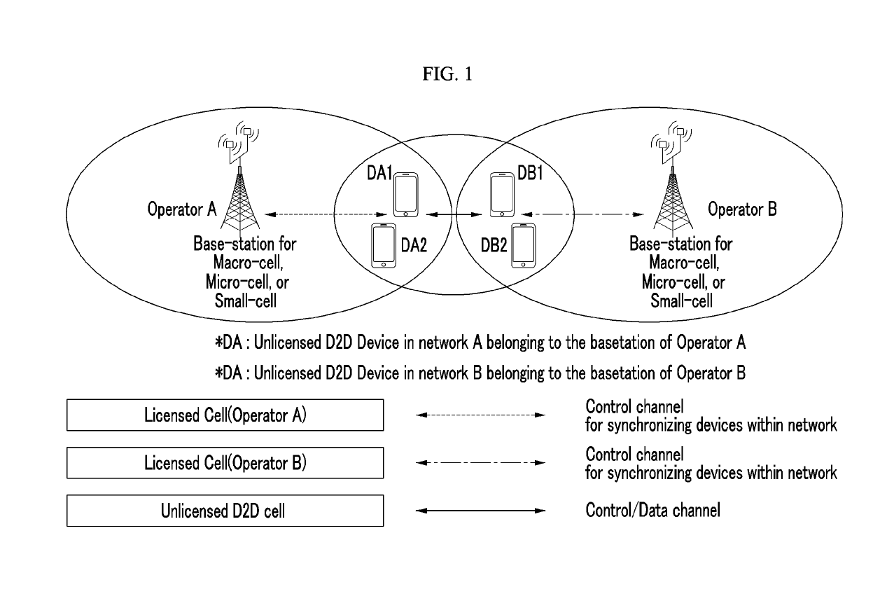

FIG. 1 shows a heterogeneous network environment according to an exemplary embodiment of the present invention.

In FIG. 1, a case in which networks consisting of Device-to-Device (D2D) terminals communicate with each other in an environment in which bases stations belonging to different wireless operators coexist is shown as an example. Here, for convenience of explanation, it will be referred to as a network that consists of terminals using an unlicensed band among terminals belonging to a base station.

The D2D terminals (DA1 and DA2 in FIG. 1) that use an unlicensed band and belong to a base station of a wireless operator A perform synchronization between them and other operations through a control channel of a licensed band provided by the base station. Also, the D2D terminals (DB1 and DB2 in FIG. 1) that use an unlicensed band and belong to a base station of a wireless operator B perform synchronization between them and other operations through a control channel of a licensed band provided by the base station. The terminals DA1 and DA2 belonging to the base station of the wireless operator A and the terminals DB1 and DB2 belonging to the base station of the wireless operator B use an unlicensed band.

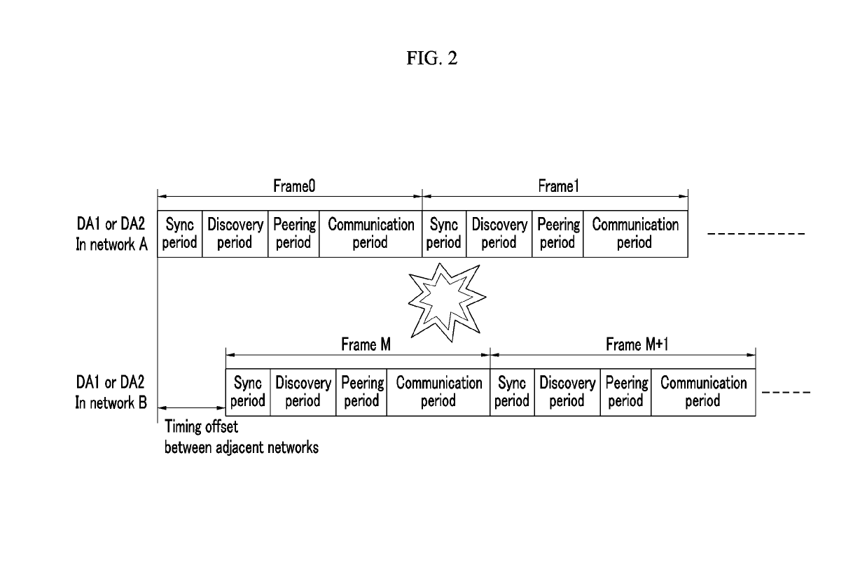

FIG. 2 shows an example of a frame structure according to an exemplary embodiment of the present invention.

A frame includes a plurality of periods arranged in chronological order, that is, a synchronization period, a discovery period, a peering period, and a communication period.

The synchronization period provides information on a start point of a frame. If a control channel of a licensed band provides information on the start point, the synchronization period may be omitted or simplified.

The discovery period is used when discovering terminals providing desired services or when providing the desired service of the other terminals.

The peering period is used when exchanging information and informing of its existence between terminals or terminals of interest.

The communication period is used when performing communication (voice/image/data/Internet communication, and others) between peered terminals as above.

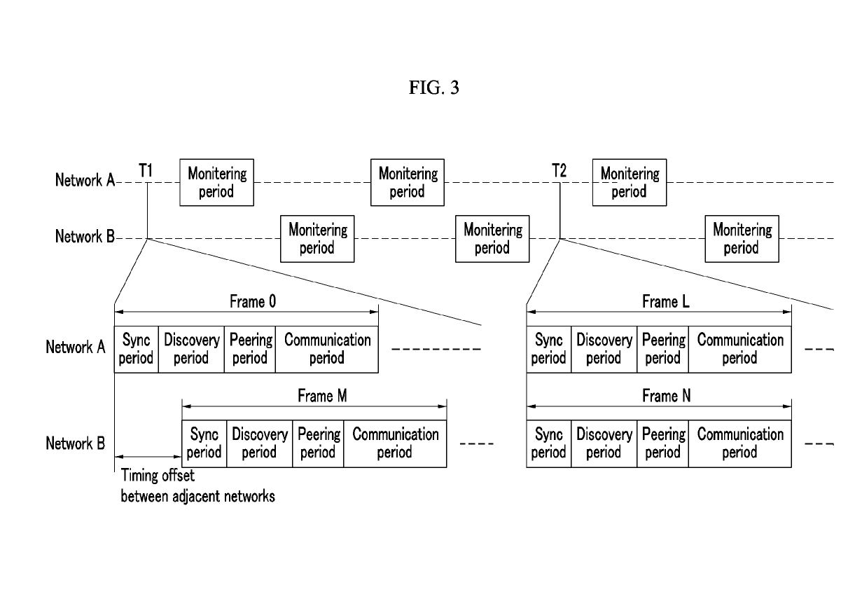

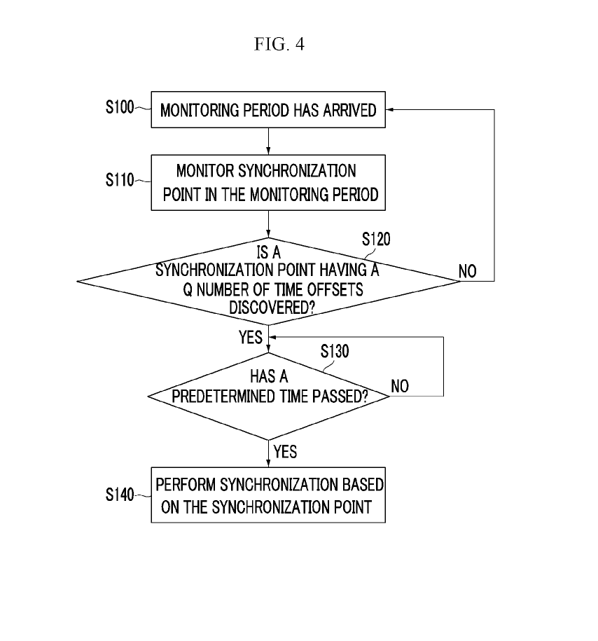

Synchronization between terminals, for example, represents that each of the terminals DA1 and DA2 in FIG. 1 obtain a start point of a frame, a System Frame Number (SFN) (here, the SFN represents a unique number of each frame), information on whether the present time period or the following time period is a monitoring period which will be described in FIG. 3, information on a cycle of the monitoring period, information on time length of the monitoring period, or information on whether the present mode is a maintaining synchronization mode or a re-synchronization mode which will be described in FIG. 4, through a control channel from a base station. It is not restricted thereto.

As in FIG. 1 according to an exemplary embodiment of the present invention, the network (e.g., network A, network B) formed by the base station of the wireless operator A or the base station of the wireless operator B includes two terminals, but is not restricted thereto. The network may include at least three terminals. Also, the networks of the tow heterogeneous wireless operators (the wireless operators A and B) are adjacent to each other, but are not restricted thereto. The case in which there are at least three heterogeneous wireless operators may be included. Further, some or all of the information provided through the control channel of the base station may be provided by a terminal which is controlled or not by the base station among D2D terminals (e.g., the terminals DA1 and DA2 in FIG. 1) belonging to the network of the base station or be provided through the cooperation of the terminals. Here, all of the methods for designating a terminal or cooperating with terminals, which may be embodied by a person of ordinary skill in the art, may be applied.

In addition, as shown in FIG. 1, in the network A including the terminals DA1 and DA2, the terminal DA1 and the terminal DA2 are synchronized with each other through the control channel of the corresponding base station. Likewise, in the network B including the terminals DB1 and DB2, the terminal DB1 and the terminal DB2 are synchronized with each other through the control channel of the corresponding base station. However, as shown in FIG. 2, there may be a timing offset between the network A and the network B. The timing offset causes interference which is not controlled between the networks, and thereby system capacity may be deteriorated.

According to an exemplary embodiment of the present invention, when there are different networks which belong to different wireless operators, respectively, synchronizing the networks is performed.

FIG. 3 shows a process for synchronizing networks according to an exemplary embodiment of the present invention.

When there are two different networks (network A and network B) which belong to different wireless operators, respectively, for synchronizing the networks network, a monitoring control method is used.

The terminals of each network obtain information on synchronization and information on a period of monitoring other networks through a control channel of a base station to which the terminals belong, a control channel provided by a terminal controlled under the base station, or the cooperation of the terminals.

The monitoring period may be periodically set while mapping with an SFN or may be aperiodically set while mapping with an SFN at a time. The monitoring periods of the networks A and B in FIG. 3 are repeated the same every period, while the positions of the monitoring periods are not synchronized with each other. That is, the position of the motoring period by a network is set such that different networks of different wireless operators do not share information on the position of the motoring period unless the wireless operators cooperate with each other, and thereby the less the possibility of overlaying the monitoring periods of different networks is, the more the cycle of the monitoring period is. At a time point T1 in FIG. 3, that is, a time point before performing monitoring, it is synchronized in a network, while it is not synchronized between networks, which causes a timing offset.

After the time point T1 has passed, when a monitoring period has arrived first in the network A, all of the terminals in the network A operate in a reception mode and monitor whether there is a different network in a region to which the terminals belong. This means that there is a different network that represents that a synchronization point is discovered periodically at different time points from the start point of a frame in the reception mode. When discovering the synchronization point, that is, a new start point of a frame in the monitoring period, all of the terminals in the network A adjust the synchronization with the new start point. For discovering periodic synchronization points, the length of the monitoring period may be an integer multiple of a time length of a frame or may be approximated to the integer multiple of a time length.

In the first exemplary embodiment of the present invention, a method for all of the terminals in the network A to synchronize with the network B is provided, and for this purpose, the first to third synchronization methods are used.

The first synchronization method is a method in which the frame start synchronization point of the network A is synchronized with the frame start synchronization point of the network B after a predetermined time when a synchronization point having a time offset of as much as a Q (Q>=1) number of frame periods is first discovered.

FIG. 4 shows a flowchart of the first synchronization method according to the first exemplary embodiment of the present invention.

A terminal in the network A, as shown in FIG. 4, operates a reception mode and monitors whether there is a different network in a region to which the terminal belongs when a monitoring period has arrived after a time T1 (S100 and S110).

As the result of the monitoring, when synchronization points having a time offset of as much as a predetermined number, for example, a Q number of frame periods, are discovered (S120), the terminal counts a predetermined time.

When the predetermined time has passed (S130), the terminal in the network A performs synchronization based on the synchronization point. That is, the frame start synchronization point of the network A is synchronized with the frame start synchronization point of the network B (S140).

Meanwhile, the second synchronization method is a method in which offset information is transmitted after a predetermined time and the frame start synchronization point of the network A is synchronized with the frame start synchronization point of the network B when a synchronization point having a time offset of as much as a Q (Q>=1) number of frame periods is first discovered.

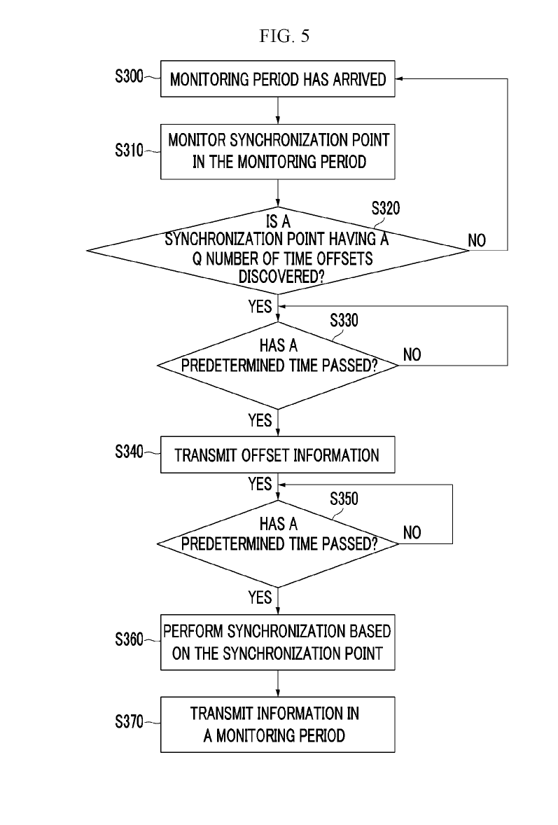

FIG. 5 shows a flowchart of the second synchronization method according to the first exemplary embodiment of the present invention.

A terminal in the network A, as shown in FIG. 5, operates a reception mode and monitors whether there is a different network in a region to which the terminal belongs when a monitoring period has arrived after a time T1 (S300 and S310).

As the result of the monitoring, when a synchronization point having a time offset of as much as a predetermined number, for example, a Q number of frame periods, is discovered (S320), the terminal transmits offset information after a predetermined time (S330 and S340). Specifically, the terminal transmits offset information indicating that the frame start synchronization point moves from a synchronization period located in the start time portion of a frame of the network A or other periods of the frame to a frame of the network B. The offset information may be, for example, one among mode=0, mode=1, timing offset=0, and timing offset≠0. The mode=0 indicates not moving to the network (e.g., network B) corresponding to the discovered synchronization point, and the mode=1 indicates moving to the network. The timing offset=0 indicates not moving to the network, and the timing offset≠0 indicates moving to the network and simultaneously moving to the network by a value of offset. The meaning of moving to the network corresponding to the discovered synchronization point represents that the frame start synchronization point is adjusted with the discovered synchronization point. That is, it means that the frame start synchronization point of the network A is synchronized with the frame start synchronization point of the network B.

After transmitting the offset information, when the predetermined time has passed (S350), the terminal in the network A synchronize the frame start synchronization point of the network A with the frame start synchronization point of the network B (S360). After that, the terminal transmits information indicating maintaining synchronization in the synchronization period located in the start time portion of the frame of the network to which the terminal moved, and the information may include for example, the mode=0 or the timing offset=0 (S370).

Through the above process, the problems of network synchronization caused by the reason that the terminal in the network A does not discover at least one synchronization point having a time offset of as much as a Q number of frame periods may be prevented. Here, since the terminals in the network B do not perform monitoring, they are capable of transmitting a frame including the mode=0 or the timing offset=0.

Meanwhile, the third synchronization method is a method in which the frame start synchronization point of the network A is synchronized with the frame start synchronization point of the network B according to the information transmitted from the network B after a predetermined time when a synchronization point having a time offset of as much as a Q−1 (Q>=2) number of frame periods is first discovered.

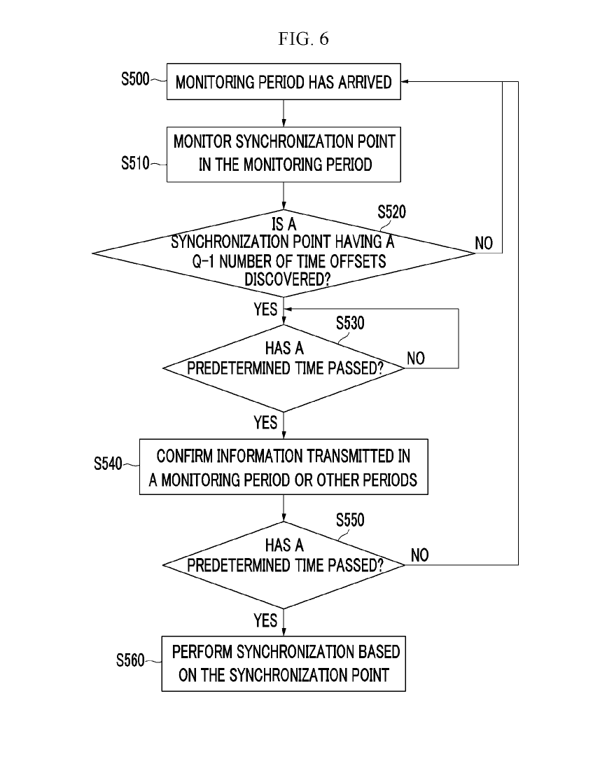

FIG. 6 shows a flowchart of the third synchronization method according to the first exemplary embodiment of the present invention.

A terminal in the network A, as shown in FIG. 6, operates a reception mode and monitors whether there is a different network in a region to which the terminal belongs when a monitoring period has arrived after a time T1 (S500 and S510).

As the result of the monitoring, when a synchronization point having a time offset of as much as a Q−1 (Q>=2) number of frame periods is discovered (S520), after a predetermined time (S530), the terminal confirms information that the terminals in the network B transmit in a synchronization period located in the start time portion of a frame of the network B or other periods of the frame (S540). Here, the information transmitted by the terminals in the network B may include the mode=0 or the timing offset=0 and be transmitted in a specific period every frame to maintain consistency.

When the information transmitted by the terminals in the network in the period includes predetermined information, for example, information indicating not moving to a network to maintain frame synchronization, that is, when the information includes the mode=0 or the timing offset=0, the terminal in the network A synchronizes the frame start synchronization point of the network A with the frame start synchronization point of the network B (S550 and S560). Specifically, after a predetermined time, the terminal in the network A performs synchronization with the network B.

In the first exemplary embodiment of the present invention, the terminals in the network A may use at least one among the first to third synchronization methods to synchronize with the network B and may combine and use at least two methods in some cases.

If all terminals in the network A, as shown in FIG. 3, perform the above synchronization method in the monitoring period following the time T1, when the terminals in the network B perform monitoring in the monitoring period of the network B later than the monitoring period of the network A in time, the terminals in the network B may discover the same synchronization point as its frame start synchronization point. Therefore, the terminals in the network B may maintain its network synchronization. The meaning of maintaining its network synchronization includes maintaining its frame start synchronization point without moving to another frame start synchronization point. Accordingly, at the time T2 in FIG. 3, it is known that the networks A and B are synchronized with each other, and the frame numbers may be different. That is, when the network A and the network B perform synchronization in each monitoring period, the synchronization point of the network A is the same as that of the network B while the frame numbers of the synchronization points are different. Accordingly, a terminal may recognize that another network is synchronized with its network.

Meanwhile, if there is only one network A belonging to a wireless operator, network synchronization may be performed as follows.

After the time point T1 in FIG. 3 has passed, when a monitoring period has arrived first in the network A, all of the terminals in the network A operate in a reception mode and monitor whether there is a different network in a region to which the terminals belong. As the result of the monitoring, if a synchronization point is not discovered, the terminal in the network A determines that there is no different network in the region and then maintains its frame start synchronization point. Specifically, since there is no newly discovered synchronization point, the terminal recognizes that there is no different network and then maintains its frame start synchronization point.

In the meantime, when there are three networks (e.g., networks A, B, and C) which belong to different wireless operators, respectively, network synchronization may be performed as follows.

According to the second to fifth exemplary embodiments of the present invention, a method for synchronizing the three networks among the different wireless operators is provided.

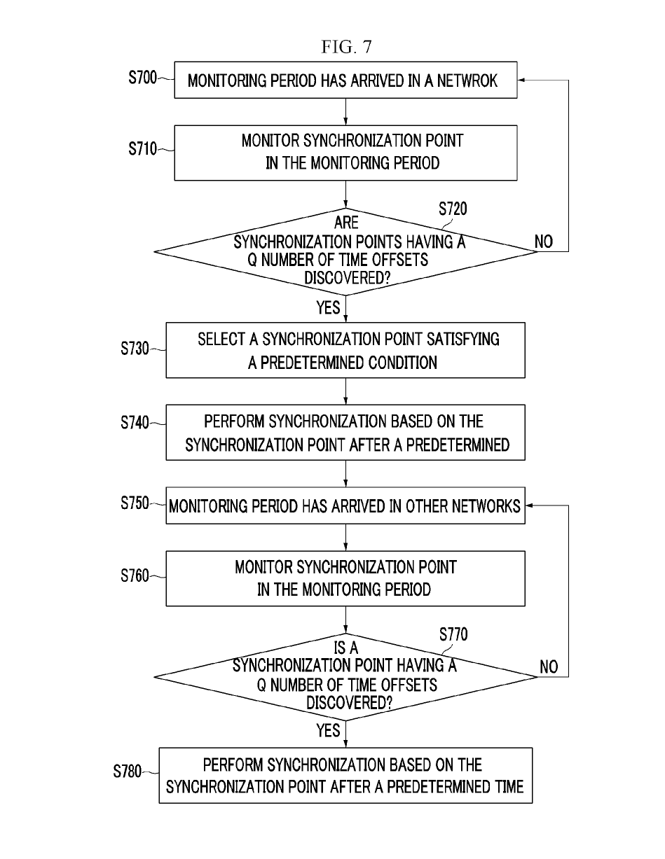

FIG. 7 shows a flowchart of a method for synchronizing according to the second exemplary embodiment of the present invention.

Here, network synchronization will be described while focusing on the difference from the first exemplary embodiment based on FIG. 3.

As above, a terminal belonging to each network obtains information on synchronization and information for monitoring a different network through a control channel of the corresponding base station, a control channel provided by a terminal under the corresponding base station, or cooperation between the terminals. In the case in which a timing offset occurs due to asynchronization between the networks A, B, and C, when a monitoring period has arrived, a terminal operates in a reception mode and then monitors whether there is a different network in the region to which the terminal belongs. It is assumed that the monitoring period arrival order is the networks A, B, and C.

As shown in FIG. 7, when a monitoring period has arrived first in the network A, all terminals in the network A operate in a reception mode and then monitor whether there is a different network in the region to which the terminals belong (S700 and S710).

As the result of the monitoring, when synchronization points having a time offset of as much as a Q (Q>=1) number of frame periods are discovered, that is, two synchronization points are discovered (S720), the terminal selects a synchronization point of which a time offset satisfies a predetermined condition among them (S720 and S730). For example, a synchronization point having the minimum (or the maximum) timing offset between itself and the synchronization point of the network A is selected from among the discovered synchronization points.

Then, the terminal performs synchronization based on the selected synchronization point after a predetermined time (S740). That is, the frame start synchronization point of the network A is synchronized with the frame start synchronization point of the network that has the minimum (or the maximum) timing offset between itself and the synchronization point of the network A.

After that, the synchronization of the other networks (the networks B and C) is performed as the first exemplary embodiment. That is, a terminal in the network in which a monitoring period has arrived performs monitoring in the monitoring period and performs synchronization based on a discovered synchronization point.

In detail, it is assumed that the network having the minimum (or the maximum) timing offset between itself and the synchronization point of the network A is the network B. When a monitoring period has arrived in the network B which has been synchronized with the network A, all terminals in the network B operate a reception mode and monitor whether there is a different network in a region to which the terminals belong (S750 and S760).

As the result of the monitoring, when a synchronization point having a time offset of as much as a Q (Q>=1) number of frame periods is discovered (S770), all terminals in the network B synchronize the frame start synchronization point of the network B with the frame start synchronization point of the network C corresponding to the discovered synchronization point after a predetermined time (S780).

All terminal in the network C perform synchronization the same as the network B's synchronization.

Specifically, when a monitoring period has arrived in the network C which has been synchronized with the network B, all terminals in the network C operate a reception mode and monitor whether there is a different network in a region to which the terminals belong (S750 and S760).

As the result of the monitoring, when a synchronization point having a time offset of as much as a Q (Q>=1) number of frame periods is discovered (S770), all terminals in the network C synchronize the frame start synchronization point of the network C with the frame start synchronization point of the network B corresponding to the discovered synchronization point after a predetermined time (S780).

As the above, the number of monitoring periods is determined in proportion to the number of different networks that belong to different wireless operators in some regions. Synchronization between the networks of the wireless operators is completed when the time of as much as the number of monitoring periods has passed.

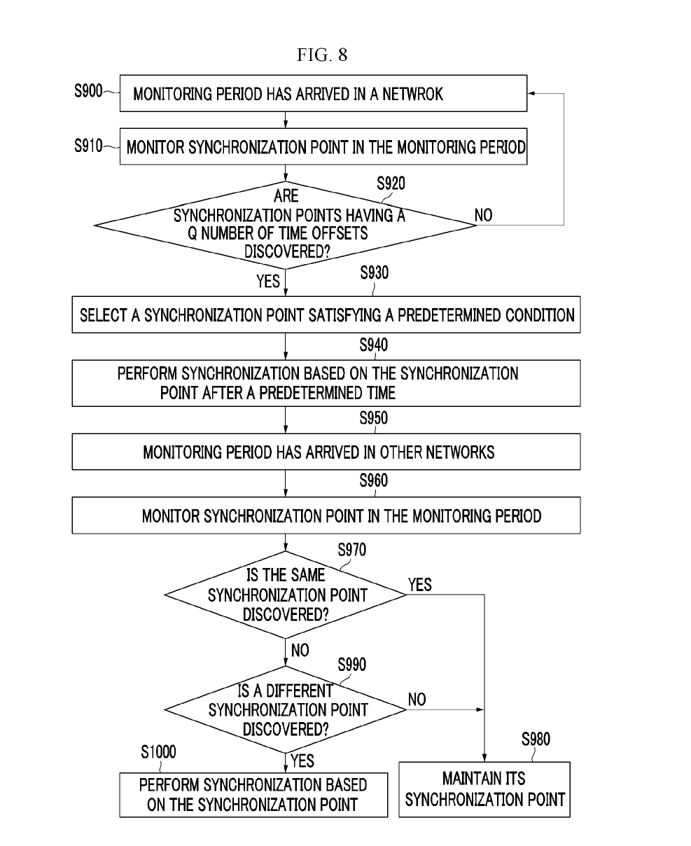

FIG. 8 shows a flowchart of a method for synchronizing according to the third exemplary embodiment of the present invention.

For convenience of explanation, in the third exemplary embodiment, the detailed description will be omitted for the same contents as in the second exemplary embodiment.

It is assumed that the monitoring period arrival order is the networks A, B, and C in the case in which a timing offset occurs due to asynchronization between the networks A, B, and C.

As shown in FIG. 8, when a monitoring period has arrived first in the network A, if a terminal in the network A discovers two different synchronization points from its synchronization point, the terminal selects a synchronization point of which a time offset satisfies a predetermined condition among the two different synchronization points (S900 to S940).

If the selected synchronization point belongs to the network B, the network A is synchronized with the network B (S900-S940).

After that, when a monitoring period has arrived first in the network B, if a terminal in the network B discovers a synchronization point that is equal to its synchronization point and has a different frame number from that of its synchronization point (S950 to S970), the terminal in the network B maintains its synchronization point (S980).

If the synchronization point that is equal to its synchronization point and has a different frame number from that of its synchronization point is not discovered and a different synchronization point from its synchronization point is discovered, the terminal in the network B performs synchronization based on the discovered synchronization point (S990 to S1000). For example, if the synchronization point of the network C is discovered, the network B is synchronized with the network C. If the synchronization point that is equal to its synchronization point and has a different frame number from that of its synchronization point is not discovered and the different synchronization point from its synchronization point is not discovered, the terminal in the network B maintains its synchronization point (S980).

All terminal in the network C perform synchronization the same as the network B's synchronization.

When a monitoring period has arrived first in the network C according to the monitoring period arrival order, if a terminal in the network C discovers a synchronization point that is equal to its synchronization point and has a different frame number from that of its synchronization point (S950 to S970), the terminal in the network C maintains its synchronization point (S980). If the synchronization point that is equal to its synchronization point and has a different frame number from that of its synchronization point is not discovered and a different synchronization point from its synchronization point is discovered, for example, the synchronization point of the network B is discovered, the terminal in the network C synchronizes its synchronization point with the synchronization point of the network B (S990 to S1000). If the synchronization point that is equal to its synchronization point and has a different frame number from that of its synchronization point is not discovered and the different synchronization point from its synchronization point is not discovered, the terminal in the network B maintains its synchronization point (S980).

Whenever a monitoring period has arrived, the networks A, B, and C perform synchronization as described above.

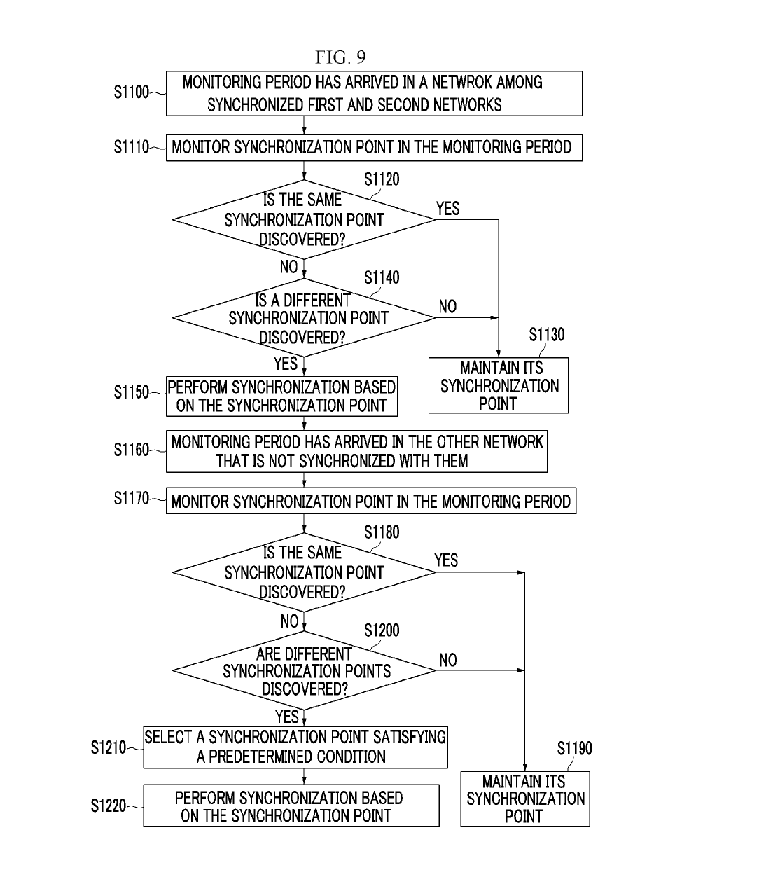

FIG. 9 shows a flowchart of a method for synchronizing according to the fourth exemplary embodiment of the present invention.

For convenience of explanation, in the fourth exemplary embodiment, the detailed description will be omitted for the same contents as in the second exemplary embodiment.

It is assumed that the networks A and B are synchronized with each other and the network A (or the network B) and the network C are not synchronized. It may be, for example, a case in which the network C participates in the region in which the networks A and B are synchronized with each other. In addition, it is assumed that the networks A and B perform monitoring every monitoring period even though they are synchronized with each other in the fourth exemplary embodiment of the present invention, and the monitoring period arrival order is the networks A, B, and C.

As shown in FIG. 9, when a monitoring period has arrived first in the network A, if a terminal in the network A discovers a synchronization point that is equal to its synchronization point and has a different frame number from that of its synchronization point (S1100 to S1120), the terminal in the network A maintains its synchronization point (S1130). If the synchronization point that is equal to its synchronization point and has a different frame number from that of its synchronization point is not discovered and a different synchronization point from its synchronization point is discovered, the terminal in the network A performs synchronization based on the discovered synchronization point (S1140 and S1150). For example, if the synchronization point of the network C is discovered, the network A is synchronized with the network C. If the synchronization point that is equal to its synchronization point and has a different frame number from that of its synchronization point is not discovered and the different synchronization point from its synchronization point is not discovered, the terminal in the network A maintains its synchronization point (S1130).

All terminals in the network B which is synchronized with the network A perform synchronization the same as the network A's synchronization.

Specifically, when a monitoring period has arrived first in the network B according to the monitoring period arrival order, if a terminal in the network B discovers a synchronization point that is equal to its synchronization point and has a different frame number from that of its synchronization point (S1100 to S1120), the terminal in the network B maintains its synchronization point (S1130). If the synchronization point that is equal to its synchronization point and has a different frame number from that of its synchronization point is not discovered and a different synchronization point from its synchronization point is discovered, for example, the synchronization point of the network C is discovered, the terminal in the network B performs synchronization to the network C (S1140 and S1150). If the synchronization point that is equal to its synchronization point and has a different frame number from that of its synchronization point is not discovered and the different synchronization point from its synchronization point is not discovered, the terminal in the network B maintains its synchronization point (S1130).

After that, when a monitoring period has arrived first in the network C, if a terminal in the network C discovers a synchronization point that is equal to its synchronization point and has a different frame number from that of its synchronization point (S1160 to S1180), the terminal in the network C maintains its synchronization point (S1190). If the synchronization point that is equal to its synchronization point and has a different frame number from that of its synchronization point is not discovered and different synchronization points from its synchronization point are discovered, the terminal in the network C performs synchronization based on a predetermined condition (S1200 to S1220). For example, the terminal in the network C selects a synchronization point having the minimum (or the maximum) timing offset between itself and the synchronization point of the network C and then performs synchronization based on the selected synchronization point.

If the synchronization point that is equal to its synchronization point and has a different frame number from that of its synchronization point is not discovered and a different synchronization point from its synchronization point is not discovered, the terminal in the network C maintains its synchronization point (S1190).

Whenever a monitoring period has arrived, the networks A, B, and C perform synchronization as described above.

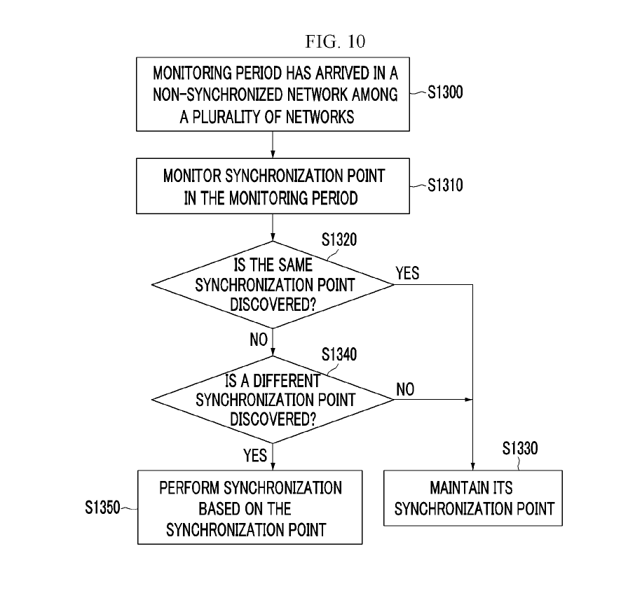

FIG. 10 shows a flowchart of a method for synchronizing according to the fifth exemplary embodiment of the present invention.

For convenience of explanation, in the fifth exemplary embodiment, the detailed description will be omitted for the same contents as in the second exemplary embodiment. It is assumed that the networks A and B are synchronized with each other and the network A (or the network B) and the network C are not synchronized. It may be, for example, a case in which the network C participates in the region in which the networks A and B are synchronized with each other. In addition, it is assumed that the networks A and B do not perform monitoring every monitoring period since they are already synchronized with each other in the fourth exemplary embodiment of the present invention, and only the network C performs monitoring.

As shown in FIG. 10, when a monitoring period has arrived in the network C, if a terminal in the network C discovers a synchronization point that is equal to its synchronization point and has a different frame number from that of its synchronization point, the terminal in the network C maintains its synchronization point (S1300 to S1330). If the synchronization point that is equal to its synchronization point and has a different frame number from that of its synchronization point is not discovered and a different synchronization point from its synchronization point is discovered, the terminal in the network C performs synchronization based on the discovered synchronization point (S1340 and S1350). For example, if the synchronization point of the network A (or the network B) is discovered, the network C is synchronized with the network A (or the network B). If the synchronization point that is equal to its synchronization point and has a different frame number from that of its synchronization point is not discovered and the different synchronization point from its synchronization point is not discovered, the terminal in the network C maintains its synchronization point (S1330).

Whenever a monitoring period has arrived, the network C performs synchronization as described above.

The methods for synchronizing according to the second to fifth exemplary embodiments of the present invention may be applied to the case of synchronizing at least four networks. Therefore, the method for synchronizing at least four networks may be in the scope of the present invention.

Meanwhile, according to the status in which the heterogeneous networks coexist in a region, all terminals, some terminals, or a terminal under a base station belonging of each wireless base station informs the base station of the status through a control channel of a licensed band of the base station. The base station having received the informing control channel transmits information on a length of a monitoring period or a cycle of a monitoring period to a terminal, some terminals, or all terminals. For example, if the base station receives the informing of the status in which the heterogeneous networks do not coexist in a region, the base station transmits information regarding no monitoring period to a terminal, some terminals, or all terminals through a control channel to prevent waste of resource. If the base station receives the informing of the status in which the many heterogeneous networks coexist in a region, the base station transmits information on a very short cycle of a monitoring period to a terminal, some terminals, or all terminals through a control channel to prevent waste of resource.

The length or cycle of the monitoring period may be adjusted through the cooperation of the terminals without the base station's control depending on how many heterogeneous operators coexist.

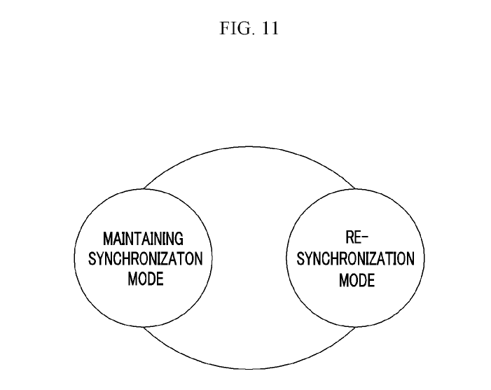

The method for synchronizing networks among heterogeneous operators according to the fifth exemplary embodiment of the present invention may be described by the state transition to two modes as in FIG. 11.

FIG. 11 shows the state transition of modes according to an exemplary embodiment of the present invention.

A maintaining synchronization mode may represent the start in which terminals of each network may perform synchronization under the control of a base station. A re-synchronization mode may represent that terminals of each network may be under a monitoring period.

By using the above-described monitoring control method, that is, the methods for synchronizing, a terminal operates in the maintaining synchronization mode when there is no different network in a monitoring period and operates in the re-synchronization mode to perform network synchronization when there is a different network in a monitoring period. If a different network is not discovered after performing the network synchronization, transition to the maintaining synchronization mode occurs.

In the above exemplary embodiments of the present invention, it assumed that a network is in a wireless operator, but is not limited thereto. For example, a plurality of networks may in a wireless operator. In this case, for synchronizing the networks, each network may have a different length and a different cycle for a monitoring period.

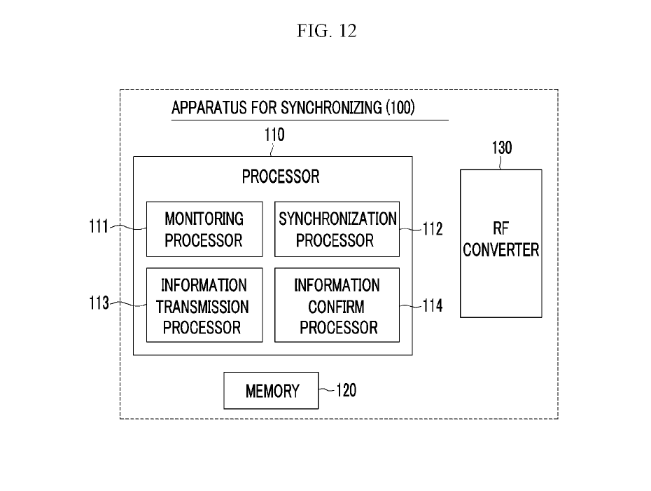

FIG. 12 shows a block diagram illustrating a configuration of an apparatus for synchronizing networks according to an exemplary embodiment of the present invention.

As shown in FIG. 12, the apparatus 100 includes a processor 110, a memory 120, and a Radio Frequency (RF) converter 130. The processor 110 may be configured by implementing the above steps and methods based on FIG. 3 to FIG. 10.

For this purpose, the processor 110 includes a monitoring processor 111, a synchronization processor 112, an information transmission processor 113, and an information confirm processor 114.

The monitoring processor 111 monitors a monitoring period to determine whether there is a different network in its region and to discover a synchronization point.

The synchronization processor 112 operates in the maintaining synchronization mode when there is no different network and operates in the re-synchronization mode to perform network synchronization as stated above when there is a different network in a monitoring period based on the result of the monitoring. The synchronization processor 112 performs synchronization by using at least one among the first to third synchronization methods. Also, the synchronization processor 112 performs synchronization by using at least one among the methods shown in FIG. 7 to FIG. 19 according to the second to the fifth exemplary embodiments of the present invention when there are networks that belong to three different wireless operators, respectively.

The information transmission processor 113 transmits information in a predetermined period (e.g., a synchronization period located in the start time portion of a frame or other periods) of a frame. For example, the information transmission processor 113 transmits offset information indicating moving to the network that corresponds to the discovered synchronization point. The offset information includes one among mode=0, mode=1, timing offset=0, and timing offset≠0. The information transmission processor 113 transmits information, example, mode=0 or timing offset=0 indicating not performing monitoring in a monitoring period located in the start time portion of the frame of the moved network.

The information confirm processor 114 confirms the information transmitted in a period of a frame by the terminals belonging to different networks, for example, the synchronization period located in the start time portion of the frame or other periods, and transmits the results of confirming to the synchronization processor 112. The synchronization processor 112 performs synchronization according to the third synchronization method based on the results provided from the information confirm processor 114.

The memory 120 is connected to a processor 110 and stores various information associated with an operation of the processor 110. The RF converter 130 is connected to the processor 110 and transmits or receives a wireless signal.

According to the exemplary embodiments of the present invention, it is possible to synchronizing unlicensed band-based networks among heterogeneous wireless operators. Even though there are networks that are not synchronized with each other, synchronization between the networks is performed. Therefore, it is possible to save the power of a terminal, and thereby the local system capacity improves.

The exemplary embodiment of the present invention described above is implemented not only by an apparatus and a method, but also by a program realizing a function corresponding to a configuration of the exemplary embodiment of the present invention or a recording medium recording the program. The above implementation may be achieved by a person of ordinary skill in the art based on the description of the above embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for synchronizing networks based on an unlicensed band, the method comprising:
monitoring, by a terminal belonging to a first network, whether there is a different network in a monitoring period of a frame;
discovering a synchronization point having a time offset of as much as a predetermined number of periods; and
synchronizing a frame start synchronization point of the first network with a frame start synchronization point of a second network that corresponds to the discovered synchronization point.

2. The method of claim 1, wherein the synchronizing comprises synchronizing a frame start synchronization point of the first network with a frame start synchronization point of a second network that corresponds to the discovered synchronization point when the synchronization point is discovered and then a predetermined time is passed.

3. The method of claim 1, further comprising
between the discovering and the synchronizing,
transmitting offset information after the synchronization point is discovered,
wherein, the transmitting of offset information transmits the offset information in a start time portion of the frame of the first network or other periods of the frame.

4. The method of claim 3, wherein the offset information comprises one among first information indicating not moving to the second network corresponding to the discovered synchronization point, second information indicating moving to the second network corresponding to the discovered synchronization point, and third information indicating moving to the second network corresponding to the discovered synchronization point the time offset.

5. The method of claim 3, further comprising
after the synchronizing,
transmitting information indicating maintaining frame synchronization in a start time portion of a frame of the second network.

6. The method of claim 1, further comprising
between the discovering and the synchronizing,
confirming information transmitted in a predetermined period of a frame of the second network,
wherein the confirming confirms information transmitted in a start time portion of a frame of the second network or other periods of the frame.

7. The method of claim 6, wherein the synchronizing comprises
synchronizing a frame start synchronization point of the first network with a frame start synchronization point of a second network that corresponds to the discovered synchronization point when the confirmed information indicates maintain frame synchronization.

8. The method of claim 1, further comprising
between the discovering and the synchronizing,
selecting one from among a plurality of synchronization points when the plurality of synchronization points are discovered,
wherein the selecting comprises selecting a synchronization point of which a time offset satisfies a predetermined condition from the discovered plurality of synchronization points, and
the synchronizing comprises synchronizing a frame start synchronization point of the first network with a frame start synchronization point of a second network that corresponds to the selected synchronization point.

9. A method for synchronizing at least three networks based on an unlicensed band,
wherein the at least three networks monitor in a monitoring period that arrives based on monitoring period arrival order, the method comprising:
monitoring, by a terminal belonging to a first network among the at least three networks, in a monitoring period of a frame, whether a synchronization point is discovered in different time points from a start point of the frame;
operating in a re-synchronization mode when at least one synchronization point is discovered in the monitoring period and synchronizing a frame start synchronization point of the first network with a frame start synchronization point of a second network that corresponds to the discovered synchronization point; and
operating in a maintaining synchronization mode when a synchronization point is discovered in the monitoring period.

10. The method of claim 9, further comprising:
monitoring, by a terminal belonging to a second network among networks except the first network, in a monitoring period of a frame, whether a synchronization point is discovered;
operating, by the terminal belonging to the second network, in a maintaining synchronization mode when a synchronization point that is equal to its frame start point and has a different frame number from that of its frame is discovered; and
synchronizing, by the terminal belonging to the second network, a frame start synchronization point of the second network with a frame start synchronization point of a network that corresponds to a discovered synchronization point when the synchronization point that is not equal to its frame start point and has a different frame number from that of its frame is discovered.

11. The method of claim 9, further comprising:
monitoring, by a terminal belonging to a second network that is synchronized with the first network among networks except the first network, in a monitoring period of a frame, whether a synchronization point is discovered;
operating, by the terminal belonging to the second network, in a maintaining synchronization mode when a synchronization point that is equal to its frame start point and has a different frame number from that of its frame is discovered;
synchronizing, by the terminal belonging to the second network, a frame start synchronization point of the second network with a frame start synchronization point of a network that corresponds to a discovered synchronization point when the synchronization point that is not equal to its frame start point and has a different frame number from that of its frame is discovered;
monitoring, by a terminal belonging to a third network that is not synchronized with the first network among networks except the first network, in a monitoring period of a frame, whether a synchronization point is discovered;
operating, by the terminal belonging to the third network, in a maintaining synchronization mode when a synchronization point that is equal to its frame start point and has a different frame number from that of its frame is discovered; and
selecting, by the terminal belonging to the third network, one among discovered synchronization points based on a predetermined condition when the synchronization points that are not equal to its frame start point and have a different frame number from that of its frame are discovered, and synchronizing a frame start synchronization point of the third network with a frame start synchronization point of a network that corresponds to the selected synchronization point.

12. The method of claim 10, further comprising
operating, by the terminal belonging to the second network, in a maintaining synchronization mode when a synchronization point that is or is not equal to its frame start point and has a different frame number from that of its frame is not discovered.

13. The method of claim 9, wherein the first network is a network except networks that are synchronized with each other among at least three networks and the networks that are synchronized with each other have not performed monitoring,
wherein the synchronizing of a frame start synchronization point comprises synchronizing, by the terminal belonging to first second network, a frame start synchronization point of the first network with a frame start synchronization point of a network that corresponds to a discovered synchronization point when the synchronization point that is not equal to its frame start point and has a different frame number from that of its frame is discovered.

14. The method of claim 13, wherein the operating in a maintaining synchronization mode comprises:
operating, by the terminal belonging to the first third network, in a maintaining synchronization mode when a synchronization point that is equal to its frame start point and has a different frame number from that of its frame is discovered; and
operating, by the terminal belonging to the first network, in a maintaining synchronization mode when a synchronization point that is or not equal to its frame start point and has a different frame number from that of its frame is not discovered.

15. The method of claim 14, wherein the terminal receives control information on a length of a monitoring period or a cycle of a monitoring period through a control channel from a base station of a network to which the terminal belongs or through other terminals that belong to other networks.

16. An apparatus for synchronizing networks based on an unlicensed band, the apparatus comprising:
a wireless frequency converter configured to transmit/receive a signal through an antenna; and
a processor connected to the wireless frequency converter and configured to control transmission of the signal,
wherein the processor comprises:
a monitoring processor configured to monitor whether there is a different network in a monitoring period of a frame of a first network; and
a synchronization processor configured to synchronize a frame start synchronization point of the first network with a frame start synchronization point of a second network that corresponds to the discovered synchronization point when the synchronization point having a time offset of as much as a predetermined number of periods is discovered.

17. The apparatus of claim 16, further comprising
an information transmission processor configured to transmit offset information in a start time portion of the frame of the first network or other periods of the frame.

18. The apparatus of claim 17, wherein the offset information comprises one among first information indicating not moving to the second network corresponding to the discovered synchronization point, second information indicating moving to the second network corresponding to the discovered synchronization point, and third information indicating moving to the second network corresponding to the discovered synchronization point the time offset.

19. The apparatus of claim 17, wherein the information transmission processor transmits information indicating maintaining frame synchronization in a start time portion of a frame of the second network after the synchronization is performed by the synchronization processor.

20. The apparatus of claim 16, further comprising
an information confirm processor configured to confirm information transmitted in a predetermined period of a frame of the second network,
wherein the synchronization processor synchronizes a frame start synchronization point of the first network with a frame start synchronization point of a second network that corresponds to the discovered synchronization point when the confirmed information indicates maintain frame synchronization.
